(19) United States
(12) Patent Application Publication
(10) Pub. No.: US 2017/0360529 A1
(43) Pub. Date: Dec. 21, 2017

(54) GUIDE FOR PLANNING AND DRILLING FOR THE SUBSEQUENT PLACEMENT OF DENTAL IMPLANTS

(71) Applicant: PHIBO DENTAL SOLUTIONS, S.I., Sentmenat (Barcelona) (ES)

(72) Inventors: Francesc ALSINA FONT, Barcelona (ES); Antonio LÓPEZ PÉREZ, Barcelona (ES)

(73) Assignee: PHIBO DENTAL SOLUTIONS, S.I., Sentmenat (Barcelona) (ES)

(21) Appl. No.: 15/540,753

(22) PCT Filed: Dec. 23, 2015
(86) PCT No.: PCT/ES2015/070943

§ 371 Date: Jun. 29, 2017

(30) Foreign Application Priority Data
Dec. 29, 2014 (ES) P 201431942

(51) Int. Cl. A61C 1/08; A61C 8/00

(52) U.S. Cl. CPC A61C 1/084; A61C 8/0089

(57) ABSTRACT

A guide for planning and drilling for the subsequent placement of dental implants, especially indicated in cases in which angled perforations must be performed in the bone tissue based on a previously performed first vertical hole, and which essentially comprises a support, a plate with an angle at at least one of the ends thereof fastened on the support such that it may move and be detached with respect it, a guide body located at the end of the plate and a rod that in turn comprises an upper end that is joined to the support through rotation that enable the relative movement between both, and a lower end that is inserted in the bone tissue of the patient's mouth.

### BACKGROUND

### 1. Field of the Disclosure

The object of the present disclosure is a guide for planning and drilling the subsequent placement of dental implants. More specifically, the object of the drilling guide of the disclosure is to plan and guide the drilling of the bone tissue of a partially or completely edentulous patient in which a guide is needed for both depth and angle.

### 2. Discussion of the Background Art

Implantology techniques currently enable dental roots to be substituted via implants, to which the corresponding prosthesis or artificial dental piece is in turn coupled.

Today the most widely used techniques are of special application when the patient only needs one dental piece in their denture to be substituted or replaced.

However, there are patients that have a completely toothless lower or upper jaw, or even both, either naturally or after the necessary extraction of all the dental pieces. In these cases, the substitution of each of these pieces by artificial implants becomes a complicated and arduous task that, as well as being very uncomfortable and taking a long time, which entails numerous and obvious discomfort for the patient, constitutes a high cost due to both the hours involved in surgery and the large amount of material used.

To this end, different techniques for rehabilitating edentulous patients appeared a few years ago, consisting of substituting all the pieces, generally 12 or 14, of the toothless jaw by only placing four implants in the front area of said jaw, where the density of the bone is greater and therefore the osseointegration has a greater chance of success.

Two of the four necessary implants are placed vertically and the other two in an inclined manner, specifically they are placed in the rear portion, i.e., at a certain angle with respect to the vertical implant. This is so because edentulous patients have usually suffered bone loss that makes it impossible to put the implants vertically along the sufficient length in order to obtain a minimum osseointegration that guarantees the load of the prosthesis and the angle is accurate in order to place a longer implant.

Two of the more well-known implants may be cited by way of example, which are known commercially as All-on-4® or Protocol™.

The advantages of this treatment with respect to using an implant for each one of the dental pieces to be substituted are clear, since the need for fewer implants means that discomfort is reduced for the patient, the time and stress of the surgery, the total time for treatment, as well as the cost, is reduced, to which the psychological benefits that enjoying a new denture entails must be added.

This inclination when drilling the bone tissue means that the surgeon must have some kind of guide element that enables him to orient the drilling in the most accurate way possible.

For this reason, for example in the All-on-4® technique, a guide is used consisting of a thin metal plate of considerable length and small in height to which a shaft or rod with a reduced diameter is joined at the centre point thereof. This rod is introduced in a small hole performed by the surgeon in the central point of the front portion of the jaw of the patient such that, once inserted, the metal plate may be bent or moulded in order to adapt to the contour of the bone ridge of the patient.

Said plate also has a series of vertical marks uniformly distributed along the entire length thereof that enable, when performing the angled drilling, the surgeon to have a reference for the drilling inclination using the diagonal between the marks as a reference.

This technique however, has notable drawbacks. Firstly, the lack of accuracy that is provided may be cited, since although the surgeon may guide the drilling using the vertical marks of the plate as a reference, said drilling still depends on the skill of said surgeon to first drill with the appropriate angle and then maintain the inclination during drilling. Furthermore, there is a high risk of involuntary movement in both the drill and the plate itself, which in the case of the latter tends to rotate about the vertical axis that constitutes the rod thereof, which causes the drilling to be performed with the incorrect inclination.

Secondly, there is the drawback of having to perform additional drilling, however small it may be, in the mouth of the patient, which constitutes added discomfort to the stress of the surgery.

Lastly, another drawback of this solution is that the depth of the drilling is not controlled, thus making it difficult to plan in advance on a model before the surgery.

In the state of the art there are examples of guides for drilling the bone tissue of a patient with the object of subsequently placing a dental implant, whether it is the first drilling, such as in U.S. Pat. No. 6,062,856, or if there is already a first hole and other holes are to be performed at a certain distance or specific position with respect to said first hole. Examples of this last case may be seen, for example, in U.S. Pat. No. 5,741,133, U.S. Pat. No. 8,821,159 or WO200134055.

However, the guides shown in these documents do not have the possibility of guiding the drilling at an angle, thus meaning they are not useful for this purpose.

### SUMMARY

The guide for planning and drilling dental implants of the present disclosure resolves the aforementioned problems of the state of the art and constitutes a tool that is simple to use, versatile, adaptable and reusable, which guides the drilling of the bone tissue of the patient both in terms of angle and depth without the need to perform additional drilling that is not going to be used afterwards as a hole for the corresponding implant.

To this end, the drilling guide of the disclosure comprises:
A support;
An interchangeable plate fastened on the support that may move and be detached with respect to it, where said plate comprises an angle at at least one of the ends thereof, a place comprising a guide body for the drill bit or drill responsible for perforating the bone tissue with the appropriate angle and depth.
A rod, the upper end of which is joined in an articulated manner to the support through rotation means that enable a relative movement between both pieces and where the lower end of said rod is the one that is inserted in the bone tissue of the mouth of the patient, being immobilised in the same due to retention means.

Thus, once a first perforation that does not need to be angled, i.e. a vertical hole in the bone tissue located in the front portion of the mouth of the patient, has been performed the surgeon then inserts the rod of the drilling guide of the disclosure into said vertical hole.

Clearly, said surgeon will have previously selected the appropriate plate, i.e., the one in which the plate has the appropriate angle at the end thereof, and that may be from 0° to 60°, the angle α being that which is comprised between the vertical plane of the bone tissue and the axis of the angle towards the mesial, as may be schematically seen in FIG. 5.

Once the rod has been inserted in said vertical hole and said hole is secured due to the retention means, the surgeon positions the plate in the appropriate position due to the rotation means such that the body of the guide is placed so that it correspond to the area of the bone tissue where the angled drilling is to be performed.

Specifically, the angled guiding of the drill is carried out due to the fact that the guide body is positioned on the angled end of the plate, meaning that the surgeon must simply pass the drill through said guide body in order for it to be correctly inclined. Furthermore, said guide body is such that it only enables the drill bit to enter, constituting a stop so that the drill cannot advance and the hole is performed at the correct depth. More specifically, the length of the drills and the depth of the hole to be achieved in the bone tissue being known, the guide body has a height such that, as mentioned above, it constitutes a stop in order to prevent the advance of the drill once the necessary depth has been drilled.

At the same time, as well as the rotation means that enable the relative movement between the plate and the rod, said plate further comprises horizontal movement means that enable the distance of the angled end of said plate to be varied with respect to said rod. That is to say, that through said horizontal movement means it is possible to regulate the distance from the rod, and therefore from the vertical hole of the bone tissue in which said rod is inserted, to the guide body through which the drill bit is inserted with the necessary angle and depth.

Therefore, once the guide of the disclosure is positioned in the vertical hole resulting from a first perforation of the bone tissue of the patient through the rod and this being fixed to said tissue due to the retention means, the surgeon may position the guide body on any point of the mouth of the patient within a circular surface with the centre in said vertical hole and with a variable radius that may be selected through the horizontal movement means of the plate.

The advantages of the drilling guide of the disclosure are easily discerned from this description, since it enables the spatial placement of the implants to be planned, a secure and easy guide for drilling, both in terms of angle and depth, which facilitates the task of the surgeon as well as minimising errors during the drilling operation. Another advantage is that one of the vertical drill holes for placing one of the implants is used as a positioner for the guide and does not need additional perforations in the mouth of the patient, which means it is a less traumatic treatment for the patient.

### BRIEF DESCRIPTION OF THE DRAWINGS

As a complement to the description provided herein, and for the purpose of helping to make the characteristics of the disclosure more readily understandable, in accordance with a preferred practical embodiment thereof, said description is accompanied by a set of drawings constituting an integral part of the same, which by way of illustration and not limitation represent the following:

FIG. 1 shows a perspective view of the drilling guide of the present disclosure.

FIG. 2 shows an elevation view of the drilling guide of the present disclosure.

FIG. 3 shows an exploded perspective view of the elements that make up the drilling guide of the present disclosure.

FIG. 4 shows an exploded perspective view of some of the elements of FIG. 3 according to a possible embodiment of the disclosure.

Lastly, FIG. 5 shows a schematic representation of the mouth of a patient in which the angle comprised between the vertical of the bone tissue plane and the axis angle towards the mesial is represented.

### DETAILED DESCRIPTION OF THE PREFERRED EMBODIMENT

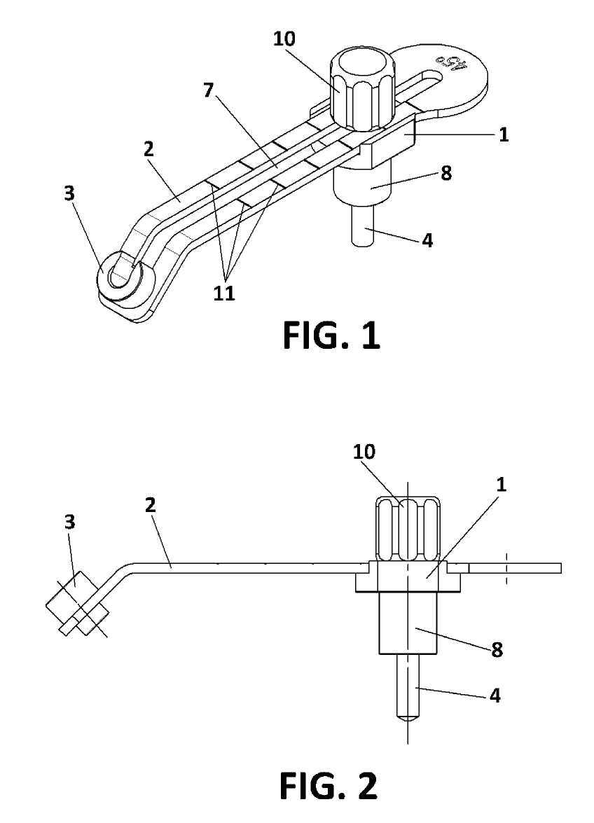

As may be seen in FIGS. 1 to 5, in which a preferred embodiment of the disclosure is shown, the guide for planning and drilling dental implants is structured such that it comprises:
A support (1);

A plate (2) in the form of a horizontal sheet that is fastened on the support (1) but may move and be detached with respect to it, and is therefore interchangeable and which comprises an angle at at least one of the ends thereof.

Furthermore, according to a possible embodiment of the disclosure, said plate (2) comprises, at at least one of the ends thereof, a means for regulating the angle (not shown) such that different angles for drilling the bone tissue may be selected using a single plate, thus removing the need to use different plates for each one of the angles. Said means for regulating the angle may be formed by, for example, a hinge or similar that, alongside the blocking means, enable the position of said end of the plate to be positioned and fixed at will or in predetermined positions and angles α, from 0° to 60°.
A guide body (3) located at the angled end of the plate (2) for correctly guiding said drill bit or drill responsible for perforating the bone tissue with the appropriate angle and depth.

According to a possible practical embodiment shown in the figures, said guide body (3) is made up of a cylindrical body that has a wide radial slot to facilitate the insertion of the drill in the case of compromised openings.

Furthermore, according to another possible embodiment of the disclosure, said guide body (3) may be detached and is interchangeable, thus enabling it to be substituted for another depending on the diameter and length of the drill, equipping the guide of the disclosure with even greater versatility.
A rod (4), preferably cylindrical, with one upper end and one lower end, wherein:
   The upper end is joined to the support (1) through rotation means (5) that enable the relative movement between both.

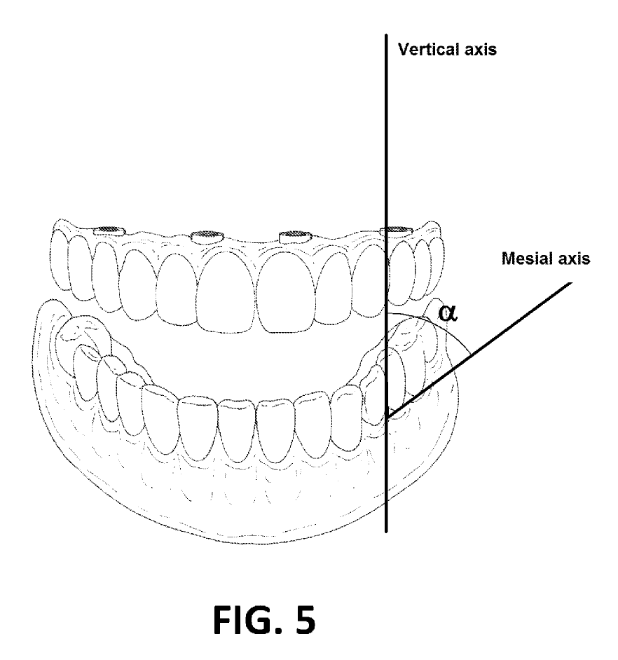

According to a possible practical embodiment, shown in FIG. 4, said rotation means (5) are formed by a ball-shaped extremity that cooperates with a spherical cavity in the support (1) such that said support (1) may rotate freely on the upper end of the rod (4), facilitating the placement and orientation thereof.
The lower end is inserted in the bone tissue of the mouth of the patient, fastening thereto due to retention means (6).

According to a possible practical embodiment of the disclosure shown in FIG. 4, said retention means (6) are constituted by a conical section that increases in diameter as it moves away from the lower end, such that adjustment between the rod (4) and the bone tissue is carried out by friction.

According to another possible embodiment, said conical section may also comprise a certain surface roughness obtained by means of any method known with the aim of improving the fastening between the rod (4) and bone tissue.

Furthermore, and as may be seen in the figures, especially in numbers 1 and 3, the plate (2) comprises horizontal movement means (7) that enable the distance between the rod (4) and the guide body (3) located at the angled end of said plate (2) to be varied.

According to a possible embodiment of the disclosure shown in said figures, the horizontal movement means (7) are formed by a rail or groove through which the assembly formed by the support (1) and the rod (4) may be moved. Specifically, in said exemplary embodiment, the movement is achieved due to the effects of a tightening element (10) that fastens the support (1) to the plate (2) by means of a second rod (12) or similar that is inserted through said rail in a hole (13) in the upper portion of the support (1).

Furthermore, it is possible to facilitate the insertion of the drill, in the cases where the openings are compromised, due to said rail or groove, which runs to the guide body (3). In other words, the rail or groove therefore has a dual function, constituting of, on the one hand, horizontal movement means (7) and, on the other hand, constituting a hole to facilitate the insertion of the drill when necessary.

Furthermore, as may be seen in the figures, the support (1) has a lower body (8) that serves to house both the second rod (12) of the tightening element (10) and the upper end of the rod (4), thus meaning that in the case in which said upper end has a ball, it has a complementary spherical cavity.

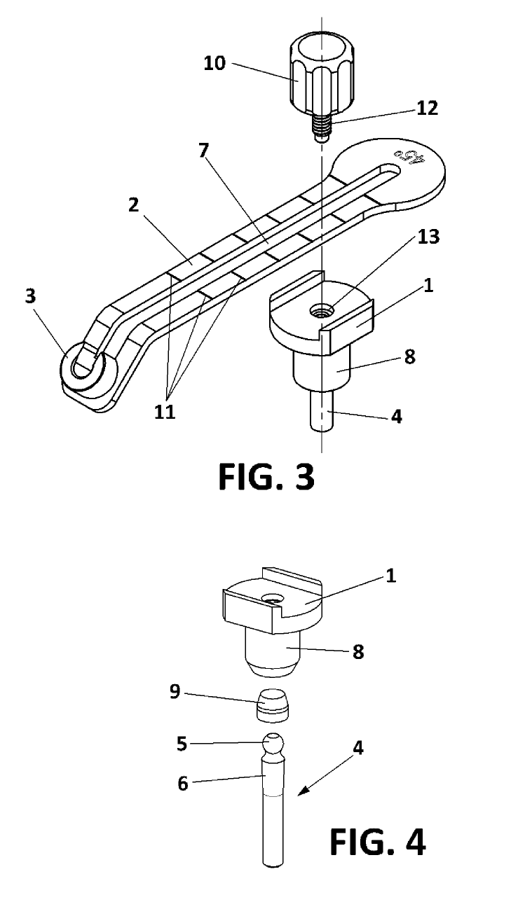

Moreover, according to a possible practical embodiment shown in FIGS. 1 and 3, the plate (2) has position markers (11) such that the surgeon may have a reference of the relative movement between the support (1) and said plate (2).

Nevertheless, according to a possible practical embodiment of the disclosure, shown in FIG. 4, said upper end of the rod (4) may be joined to the support (1) by means of an intermediate element (9) that is housed in the lower body (8) of said support (1).

Lastly, the guide of the disclosure is embodied with any material that fulfils the mechanical and biocompatibility requirements and which may be sterilised, such as metals like stainless steel or titanium, plastics, etc.

1-14. (canceled)

15. A guide for planning and drilling dental implants, comprising:
a support;
a plate fastened on the support such that it may move and be detached with respect to it;
a rod that in turn comprises:
an upper end that is rotatably joined to the support that enable the relative movement between both, and
a lower end that is insertable in the bone tissue of the mouth of the patient,
where the plate comprises horizontal movement means formed by a rail through which the assembly formed by the support and the rod may move that enable the distance between the rod and the guide body to be varied, as well as to facilitate the insertion of the drill,
wherein the plate comprises:
at least an angled end; and
a guide body located on the angled end so that the drill is inserted into the bone tissue with the appropriate angle and depth.

16. The guide for planning and drilling dental implants according to claim 15, wherein the guide body is made up of a cylindrical body that has a wide radial slot to facilitate the insertion of the drill.

17. The guide for planning and drilling dental implants according to claim 15, wherein the plate comprises, at the angled end, a hinge or similar for regulating the angle such that different angles for drilling the bone tissue may be selected using a single plate.

18. The guide for planning and drilling dental implants according to claim 15, further comprising a tightening element that fastens the support to the plate by a second rod that is complementary with a hole of the support.

19. The guide for planning and drilling dental implants according to claim 15, wherein the rotatably joint between the rod and the support is enabled by rotation means formed by a ball-shaped extremity at the upper end of the rod that cooperates with a spherical cavity of the support.

20. The guide for planning and drilling dental implants according to claim 15, wherein the lower end of the rod comprises retention means to fasten it to the bone tissue.

21. The guide for planning and drilling dental implants according to claim 20, wherein the retention means comprises a conical section that increases in diameter as it moves away from the lower end.

22. The guide for planning and drilling dental implants according to claim 20, wherein the retention means comprise a rough surface of the lower end of the rod.

23. The guide for planning and drilling dental implants according to claim 15, wherein the support has a lower body that serves as a housing for the upper end of the rod.

24. The guide for planning and drilling dental implants according to claim 15, further comprising an intermediate element through which the upper end of the rod is joined to the support.

25. The guide for planning and drilling dental implants according to claim 15, wherein the plate has position markers.

26. The guide for planning and drilling dental implants according to claim 15, wherein the guide body may be removed or interchanged.

27. The guide for planning and drilling dental implants according to claim 15, wherein said implant is made of a material that fulfils the mechanical and biocompatibility requirements and which may be sterilised.
